(19) United States
(12) Patent Application Publication
(10) Pub. No.: US 2004/0169977 A1
(43) Pub. Date: Sep. 2, 2004

(54) Overcurrent protection switched mode power supply

(76) Inventor: Tomasz Janusz Kotula, Christchurch (NZ)

Correspondence Address: MYERS BIGEL SIBLEY & SAJOVEC, PO BOX 37428, RALEIGH, NC, 27627, US

(21) Appl. No.: 10/474,567

(22) PCT Filed: Apr. 12, 2002
(86) PCT No.: PCT/NZ02/00072

(30) Foreign Application Priority Data
Apr. 12, 2001 (NZ) 511145

(51) Int. Cl. H02H 3/08

(52) U.S. Cl. 361/93.1

(57) ABSTRACT

An over-current protection circuit (3), particularly but not solely for resonant mode dc to dc converters which avoids the use of a current sensing resistor in series with the converter switching devices. A current transformer (5) is used, the secondary voltage is rectified and applied to a stable dc amplifier after careful filtering. The output (8) of the dc amplifier controls the frequency of a voltage controlled oscillator (4) which determines the switching frequency of the converter switching devices and thus the current flowing through them.

### TECHNICAL FIELD

This invention relates to a method of and a circuit for over-current protection for switched mode power supplies, in particular, but not solely, resonant mode power supplies. The invention may also have application in over-current protection for non-resonant mode power supplies and inverters.

### BACKGROUND ART

In resonant mode power supplies it is known to sense the current flowing in the switching devices and if an overload is detected to increase (or decrease as appropriate) the switching frequency to thereby reduce the power by making use of the, voltage-frequency transfer function of the supply dc-to-dc converter. U.S. Pat. 6,087,782 discloses such an over-current protection system employing a current sensing resistor.

### SUMMARY OF INVENTION

It is an object of the present invention to provide a switched mode power supply having over-current protection which avoids the need for a current sensing resistor and is stable.

Accordingly the invention consists in an over-current protection circuit for a resonant mode dc to dc converter including a switching circuit arranged across a dc supply, a transformer having at least one primary winding connected to the switching circuit output, a rectifier, the input of which is connected to the transformer secondary winding and the output supplying the converter output voltage, and a control circuit for supplying drive signals to said switching circuit, said control circuit including a voltage controlled oscillator wherein the frequency of the switching circuit drive signals is changed on detection of excessive current into the transformer primary windings so as to limit the current flowing, the improvement comprising;

a current transformer the primary winding of which is in series with a current path to said transformer primary winding from said switching circuit,

a low pass filter connected to the secondary winding of said current transformer,

a threshold detector receiving as an input the output of said low pass filter,

the output of said threshold detector connected to said voltage controlled oscillator to determine the oscillator frequency so as to change the frequency as the magnitude of the voltage across the secondary of said current transformer increases beyond a predetermined voltage to thereby limit the current flowing through said switching devices.

In a second aspect the invention consists in an over-current protection circuit for a nonresonant mode dc to dc converter or an inverter including a switching circuit arranged across a dc supply, a transformer having at least one primary winding connected to the switching circuit output, a rectifier, the input of which is connected to the transformer secondary winding and the output supplying the converter output voltage, and a control circuit for supplying drive signals to said switching circuit, said control circuit including a pulse width modulator wherein the duty cycle of the pulse width modulated switching circuit drive signals is changed on detection of excessive current into the transformer primary windings so as to limit the current flowing, the improvement comprising;

a current transformer the primary winding of which is in series with a current path to said transformer primary winding from said switching circuit,

a low pass filter connected to the secondary winding of said current transformer,

a threshold detector receiving as an input the output of said low pass filter,

the output of said threshold detector connected to said pulse width modulator to change the modulation duty cycle as the magnitude of the voltage across the secondary of said current transformer increases beyond a predetermined voltage to thereby limit the current flowing through said switching devices.

In a third aspect the invention consists in a method of over-current protection for a resonant mode dc to dc converter which includes a switching circuit arranged across a dc supply, a transformer having at least one primary winding connected to the switching circuit output, a rectifier, the input of which is connected to the transformer secondary winding and the output supplying the converter output voltage, and a control circuit for supplying drive signals to said switching circuit, said control circuit including a voltage controlled oscillator wherein the frequency of the switching circuit drive signals is changed on detection of excessive current into the transformer primary windings so as to limit the current flowing, said method comprising;

including the primary winding of a current transformer in series with a current path to said transformer primary winding from said switching circuit,

low pass filtering the output of the secondary winding of said current transformer detecting filtered voltage in excess of a threshold,

and using this voltage to determine the frequency of said voltage controlled oscillator to change the oscillator frequency as the magnitude of the voltage across the secondary of said current transformer increases beyond said threshold to thereby limit the current flowing through said switching devices.

In an inverter or non-resonant converter employing pulse width modulation (WM) the present invention could be used to decrease PWM duty cycle on the detection of overload currents.

### BRIEF DESCRIPTION OF THE DRAWINGS

FIG. 1 shows a block diagram of a dc to dc converter using a current transformer for over-current sensing,

FIG. 2 shows a circuit diagram of an over-current protection circuit employed in the dc to dc converter shown in FIG. 1,

FIG. 3 shows a waveform diagram for the current flowing in the switching devices in the converter shown in FIG. 1, and

FIG. 4 is a waveform diagram of the signal at the output of the over-current protection circuit shown in FIG. 2.

### DETAILED DESCRIPTION OF THE INVENTION

An implementation of the invention in a resonant mode dc to dc converter will now be described.

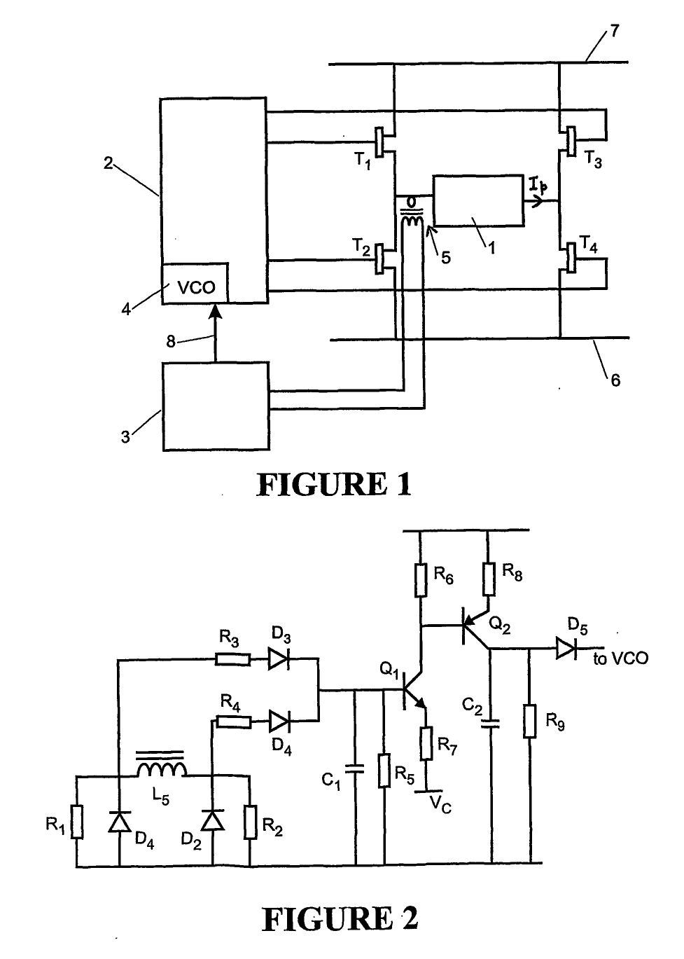

Referring to FIG. 1 the components of a simplified resonant mode dc to dc converter circuit employing over-current protection according to the present invention are shown. Four switching transistors T1 to T4 are employed in a bridge configuration between dc rails 6 and 7 to switch power through a transformer circuit 1 from which an appropriate voltage is provided for rectification to reduce the dc output of the converter. The switching of transistors T₁ to T₄ is established by a control circuit 2 which incorporates a voltage controlled oscillator 4 which determines the switching frequency.

A current transformer 5 inserted in series with the primary circuits of transformer circuit 1 (and thus the transistors T₁/T₄ and T₃/T₂) to provide an alternating current to an overcurrent protection circuit 3. The magnitude of this current is proportional to the current flowing through the switching transistors Iₚ. During an overload condition protection circuit 3 provides a dc output voltage 8 which comprises an additional input to the voltage controlled oscillator 4 to control its frequency. As the current through the switching devices increases beyond a pre-determined threshold, the control voltage 8 increases and hence the frequency of voltage controlled oscillator 4 is changed to reduce the output voltage of the converter and thus the power supplied to the load. In a non-resonant mode converter or an inverter the control voltage 8 would control the duty cycle of a pulse width modulator which would replace VCO 4.

FIG. 2 shows a circuit for implementing the functions of over-current protection circuit block 3 as represented in FIG. 1; The current in the secondary winding of current transformer 5 is rectified by two halfwave rectifier circuits D₁/R₁ and D₂/R₂ to provide two halfwave voltages. These halfwave voltages are added together in summer circuit R₃/D₃/R₄/D₄ to provide a rectified fullwave representation of the sensed current through the switching devices at the base of npn transistor Q₁.

In the case where the current transformer is in series with a current path where only the current magnitude and not its polarity changes no rectifier is necessary.

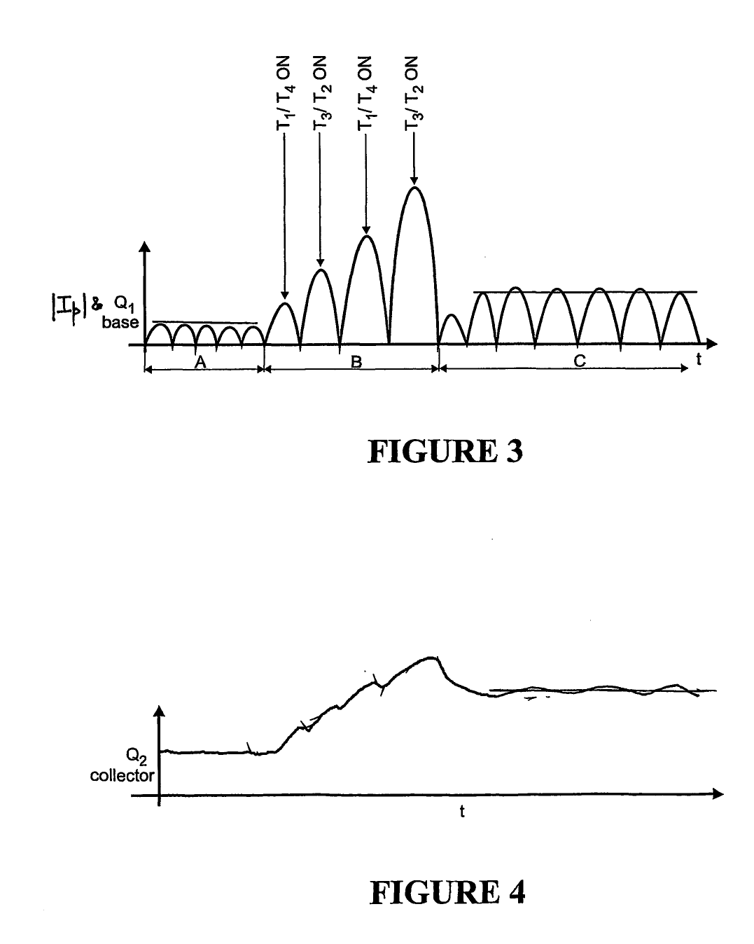

A waveform diagram for the signal on the base of transistor Q₁ is shown in FIG. 3. Portion A of the waveform indicates normal load operation, portion B overload and portion C a steady state operation resulting from the circuit response to overload.

Other forms of rectification could equally well be used, for example a current transformer having a centre tapped secondary winding with a conventional fullwave two diode rectifier or alternatively a four diode bridge rectifier could be substituted.

A low pass filter is provided at the base of transistor Q₁ comprising C₁ and R₅ and R₃ and R₄.

Transistor Q₁ together with associated components forms a threshold detector, a comparison voltage V_{C} being provided at emitter resistor R₇. This resistor also provides negative feedback for the operation of transistor Q₁ and adds to the stability of the circuit. The gain of this amplifier is set by resistors R₆ and R₇. The values of R ₈, C ₂ and R ₉ are selected to provide a suitable time constant for the second stage of the protection circuit. Transistor Q₂ provides a current source to charge C₂ to provide a steady state signal to the VCO. This signal is shown in FIG. 4 and corresponds in time to FIG. 3. R₈ and R₉ also set the gain of that stage.

Output from the protection circuit to the voltage controlled oscillator 4 is via a diode D₅ When the voltage across capacitor C₂ is higher than the VCO control voltage, diode D₅ is forward biased and hence raises the VCO control voltage. This increases the oscillator frequency and thus the frequency at which switching devices T₁ to T₄ are switched. This ensures that the circuit reaches an equilibrium and limits the current flowing through the transformer resonant circuits 1 thereby protecting switching devices T₁ to T₄.

Various modifications, alterations and variations that will readily occur to those of skill in the art are intended to be within the scope and spirit of the invention. Accordingly, the foregoing description of the preferred embodiments is by way of example only and is not intended as limiting. The scope of the invention is defined only by the following claims and the equivalents thereto.

1. In an over-current protection circuit for a resonant mode dc to dc converter including a switching circuit arranged across a dc supply, a transformer having at least one primary winding connected to the switching circuit output, a rectifier, the input of which is connected to the transformer secondary winding and the output supplying the converter output voltage, and a control circuit for supplying drive signals to said switching circuit, said control circuit including a voltage controlled oscillator wherein the frequency of the switching circuit drive signals is changed on detection of excessive current into the transformer primary windings so as to limit the current flowing, the improvement comprising;
a current transformer the primary winding of which is in series with a current path to said transformer primary winding from said switching circuit,
a low pass filter connected to the secondary winding of said current transformer,
a threshold detector receiving as an input the output of said low pass filter,
the output of said threshold detector connected to said voltage controlled oscillator to determine the oscillator frequency so as to change the frequency as the magnitude of the voltage across the secondary of said current transformer increases beyond a predetermined voltage to thereby limit the current flowing through said switching devices.

2. An over-current protection circuit for a resonant mode dc to dc converter according to claim 1 wherein a rectifier circuit is connected to the secondary winding of the current transformer, and said low pass filter is connected to the output of said rectifier circuit.

3. In an over-current protection circuit for a non-resonant mode dc to dc converter or an inverter including a switching circuit arranged across a dc supply, a transformer having at least one primary winding connected to the switching circuit output, a rectifier, the input of which is connected to the transformer secondary winding and the output supplying the converter output voltage, and a control circuit for supplying drive signals to said switching circuit, said control circuit including a pulse width modulator wherein the duty cycle of the pulse width modulated switching circuit drive signals is changed on detection of excessive current into the transformer primary windings so as to limit the current flowing, the improvement comprising;
a current transformer the primary winding of which is in series with a current path to said transformer primary winding from said switching circuit,
a low pass filter connected to the secondary winding of said current transformer,
a threshold detector receiving as an input the output of said low pass filter,
the output of said threshold detector connected to said pulse width modulator to change the modulation duty cycle as the magnitude of the voltage across the secondary of said current transformer increases beyond a predetermined voltage to thereby limit the current flowing through said switching devices.

4. An over-current protection circuit for a non-resonant mode dc to dc converter or an inverter according to claim 3 wherein a rectifier circuit is connected to the secondary winding of the current transformer, and said low pass filter is connected to the output of said rectifier circuit.

5. A method of over-current protection for a resonant mode dc to dc converter which includes a switching circuit arranged across a dc supply, a transformer having at least one primary winding connected to the switching circuit output, a rectifier, the input of which is connected to the transformer secondary winding and the output supplying the converter output voltage, and a control circuit for supplying drive signals to said switching circuit, said control circuit including a voltage controlled oscillator wherein the frequency of the switching circuit drive signals is changed on detection of excessive current into the transformer primary windings so as to limit the current flowing, said method comprising;
including the primary winding of a current transformer in series with a current path to said transformer primary winding from said switching circuit,
low pass filtering the output of the secondary winding of said current transformer detecting filtered voltage in excess of a threshold,
and using this voltage to determine the frequency of said voltage controlled oscillator to change the oscillator frequency as the magnitude of the voltage across the secondary of said current transformer increases beyond said threshold to thereby limit the current flowing through said switching devices.

6. A method of over-current protection for a resonant mode dc to dc converter according to claim 5 wherein the voltage on the secondary winding of the current transformer is rectified, and the rectified voltage is low pass filtered and used to control the frequency of said voltage controlled oscillator.

7. An over-current protection circuit for a dc to dc converter substantially as hereinbefore described with reference to the accompanying drawings.
